(19) United States
(12) Patent Application Publication
(10) Pub. No.: US 2014/0193734 A1
(43) Pub. Date: Jul. 10, 2014

(54) Fuel Cell System Having a Pump and Related Method

(71) Applicant: Lilliputian Systems, Inc., Wilmington, MA (US)

(72) Inventors: Alan P. Ludwiszewski, Andover, MA (US); Samuel B. Schaevitz, Concord, MA (US); John A. Rule, Carlisle, MA (US)

(73) Assignee: LILLIPUTIAN SYSTEMS, INC., Wilmington, MA (US)

(21) Appl. No.: 13/734,848

(22) Filed: Jan. 4, 2013

(51) Int. Cl. H01M 8/04

(52) U.S. Cl. CPC H01M 8/04089
USPC 429/444; 429/513

(57) ABSTRACT

A portable fuel cell system and related method are disclosed. The system includes a fuel cell having an anode port through which passes an anode gas, a cathode port through which passes a cathode gas, and an exhaust port through which passes an exhaust gas. The system further includes a pump having a pump inlet and a pump outlet, wherein the pump inlet is coupled to the exhaust port of the fuel cell. The pump is configured to draw the anode gas into the anode port, to draw the cathode gas into the cathode port, and to draw the exhaust gas out of the exhaust port.

### CROSS REFERENCE TO RELATED APPLICATIONS

The present application is related to U.S. patent application entitled FUEL CELL SYSTEMS AND RELATED METHODS, Attorney Docket No. 3553/138, filed on Jan. 4, 2013, U.S. patent application entitled A FUEL CELL SYSTEM HAVING AN AIR QUALITY SENSOR SUITE, Attorney Docket No. 3553/139, filed on Jan. 4, 2013, U.S. patent application entitled A FUEL CELL SYSTEM HAVING WATER VAPOR CONDENSATION PROTECTION, Attorney Docket No. 3553/142, filed on Jan. 4, 2013, U.S. patent application entitled A FUEL CELL SYSTEM HAVING A SAFETY MODE, Attorney Docket No. 3553/143, filed on Jan. 4, 2013, U.S. patent application entitled A PORTABLE FUEL CELL SYSTEM HAVING A FUEL CELL SYSTEM CONTROLLER, Attorney Docket No. 3553/144, filed on Jan. 4, 2013, U.S. patent application entitled A METHOD FOR BONDING SUBSTRATES, Attorney Docket No. 3553/145, filed on Jan. 4, 2013, and U.S. patent application entitled LOW VIBRATION LINEAR MOTOR SYSTEMS, Attorney Docket No. 3553/146, filed on Jan. 4, 2013, the disclosures of which are incorporated by reference herein in their entirety.

### TECHNICAL FIELD

The present invention is generally related to the operation of a fuel cell system and more specifically to portable fuel cell systems having a pump.

### BACKGROUND ART

Fuel cells produce electricity from chemical reactions. The chemical reactions typically cause a fuel, such as hydrogen, to react with air/oxygen as reactants to produce water vapor as a primary by-product. The hydrogen can be provided directly, in the form of hydrogen gas or liquid, or can be produced from other materials, such as hydrocarbon liquids or gases. Fuel cell assemblies may include one or more fuel cells in a fuel cell housing that is coupled with a fuel canister containing the hydrogen and/or hydrocarbons. Fuel cell housings that are portable coupled with fuel canisters that are portable, replaceable, and/or refillable, compete with batteries as a preferred electricity source to power a wide array of portable consumer electronics products, such as cell phones and personal digital assistants. The competitiveness of these fuel cell assemblies when compared to batteries depends on a number of factors, including their size, cost, efficiency, and reliability.

Providing hydrogen directly to fuel cell assemblies is typically not suitable for portable fuel cells. Hydrogen gas has a low energy density, and thus large volumes of hydrogen gas may be needed in order to provide a sufficient amount of energy to an electronic product. Liquid hydrogen typically must be stored at low temperatures and high pressure, making its storage difficult. Thus, hydrocarbon fuel sources are typically preferred for portable fuel cells.

In a high temperature fuel cell system, such as a solid oxide fuel cell (SOFC) system, an oxidizing flow is passed through the cathode side of the fuel cell while a reducing flow is passed through the anode side of the fuel cell. The oxidizing flow is typically air, while the reducing flow typically comprises a mixture of a hydrogen-rich gas created by reforming a hydrocarbon fuel source and water vapor. The fuel cell, typically operating at a temperature between 650° C. and 850° C., enables the transport of negatively charged oxygen ions from the cathode flow stream to the anode flow stream, where the ions combine with either free hydrogen or hydrogen in a hydrocarbon molecule to form water vapor and/or combine with carbon monoxide to form carbon dioxide. The excess electrons from the negatively charged ions are routed back to the cathode side of the fuel cell through an electrical circuit completed between anode and cathode, resulting in an electrical current flow through the circuit.

One or more pumps or pressurized sources located upstream of the fuel cell are typically used in the fuel cell systems to separately transport oxygen and fuel flows into the fuel cell. For portable fuel cell applications, these pumps need to be miniaturized and energy efficient. Using multiple pushing pumps for the different input streams results in significant cost and complexity. Thus, there is a need to provide a fuel cell system that is compact, inexpensive, efficient, and easy to maintain and operate.

### SUMMARY OF THE EMBODIMENTS

In accordance with one embodiment of the invention, a portable fuel cell system includes a fuel cell having an anode port through which passes an anode gas, a cathode port through which passes a cathode gas, and an exhaust port through which passes an exhaust gas. The system further includes a pump having pump inlet and pump outlet, wherein the pump inlet is coupled to the exhaust port of the fuel cell. The pump is configured to draw the anode gas into the anode port, to draw the cathode gas into the cathode port, and to draw the exhaust gas out of the exhaust port.

In accordance with another embodiment of the invention, a method for operating a fuel cell system includes providing a fuel cell with an anode port, a cathode port and an exhaust port, and a pump with a pump inlet and a pump outlet, the pump inlet coupled to the exhaust port of the fuel cell. The method further includes operating the pump to create a reduced pressure at the exhaust port, thereby drawing the exhaust gas out of the exhaust port, drawing the anode gas into the anode port, and drawing the cathode gas into the cathode port.

In related embodiments, the portable fuel cell system may include a flow restriction in a flow path into the anode port and/or into the cathode port, so as to modify a ratio of anode gas flow to cathode gas flow. The anode gas may include at least a fuel containing carbon and an oxidant containing oxygen, wherein the flow restriction is configured to provide a ratiometric mixture of fuel and oxidant such that for each carbon atom in the fuel there is supplied a number of oxygen atoms in the oxidant in a ratio, and the ratio is within the range between 0.5 and 2 oxygen atoms per carbon atom. The flow restriction may be a fixed orifice, a manually adjustable valve, and/or an electrically adjustable valve. The pump may be configured to draw the anode gas into the anode port along an anode gas flow path, the cathode port may be coupled to ambient environment and the anode gas flow path may be coupled to at least a fuel source and the ambient environment. The pump may be configured to draw the anode gas into the anode port along an anode gas flow path, and the pump outlet may be coupled to an exit path and a recirculation path, the recirculation path may be further coupled to the anode gas flow path such that a portion of the anode gas includes a portion of the exhaust gas supplied via the recirculation path. The portable fuel cell system may further include a flow restriction in the exit path, so as to modify a ratio of recirculation gas flow to cathode gas flow. The portable fuel cell system may further include a thermally coupling member in thermal communication with the pump and in thermal communication with the fuel cell. The portable fuel cell system may further include at least one check valve in a flow path into the pump inlet or pump outlet, configured such that the majority of gas passing therethrough has the same direction of flow. The thermally coupling member may be a metal strip, a heat pipe, thermal grease, forced hot air, and/or physical contact. The thermally coupling member may provide sufficient heat from the fuel cell to the pump to inhibit condensation of water in the pump. The portable fuel cell system may further include at least one flow sensor located in a flow path into the anode port and/or into the cathode port, the flow sensor configured to measure a gas flow, and the system further including a control system in electrical communication with the flow sensor and the pump, the control system configured to modulate the pump in response to measured gas flow. The fuel cell may be a solid oxide fuel cell.

The ratio of oxygen atoms to carbon atoms in the fuel cell system depends on the total air-to-fuel and exhaust gas recycle (“EGR”)-to-fuel ratios, which are interdependent operational parameters, as indicated by the following equation for the atomic oxygen-to-carbon ratio at the inlet of the anode (which is an example derived for cases in which n-butane, i-butane and/or their mixtures are utilized as fuel with dry air in which the CO₂ content is negligible):

(O/C)_{FP Inlet}=(2xyΨ)/[4(1+Ψ)]

where:

x=the mole fraction of O₂ in the air inlet

y=Total Air-to-butane flow ratio

z=EGR-to-butane flow ratio

rr (recycle ratio)=z/(2.5+y+z)

Ψ=rr/(1+rr)

Excess oxygen at the anode inlet leads to excessive combustion of fuel, leading to lower concentrations of remaining fuel components at the anode, which results in lower fuel cell efficiency. A significant oxygen excess at the anode inlet equal to or greater than the stoichiometric requirement for complete fuel combustion leads to little or no power generation from the fuel cell. For example, in the case of hydrocarbons and oxygenates, this upper limit for the oxygen-to-carbon ratio can be defined based on the following reaction stoichiometry:

CnHaOb+(n+a/4−b/2)O₂→nCO₂+(a/2)H₂O

Consequently, a maximum upper limit for oxygen-to-carbon ratio at the anode inlet of (2+a/2n) is recommended for hydrocarbons and oxygenates, and preferably, a maximum upper limit for oxygen-to-carbon ratio at the anode inlet of 2 is recommended for hydrocarbons and oxygenates (such as butanol).

Oxygen deficiency at the anode inlet can lead to at least two problems. First, gas compositions at the anode (and thus in the fuel cell anode 12) can occur in which carbon formation is thermodynamically favored and power decay could be initiated and/or accelerated due to a phenomenon well-known in the literature as “coking,” in which carbonaceous residues accumulate within the fuel cell anode 12. Second, oxygen deficiency can lead to an excess of light hydrocarbon formation in the anode, which can lead to reduced power density in the fuel cell if the anode does not have sufficiently high catalytic reforming activity for light hydrocarbons. In this regard, minimum O/C ratios at the anode inlet to avoid coking and excessive light hydrocarbon formation during fuel cell system 5 operation, either with or without exhaust gas recirculation, have been defined. Specifically, minimum O/C ratios between 0.5 and 2 are recommended under all operating conditions. More specifically, minimum O/C ratios between 1 and 2 are recommended. Preferably, minimum O/C ratios greater than 1.025, 1.251 and 1.645 at 850° C., 720° C., and 650° C., respectively, are recommended. Simple interpolation between these values can be utilized to determine minimally acceptable O/C ratios at other fuel cell system operating temperatures.

The optimization of the combustion oxidizer flow also is constrained by a lower and upper limit. The objective of the combustion region is to combust all remaining fuel into safe outputs of water and carbon dioxide. The oxygen content relevant to the combustion oxidizer flow is the molecular oxygen. Already bound oxygen is not available for participation in combustion reactions. In this case, the lower limit is the minimum molecular oxygen level which causes full conversion of the anode exhaust to combustion products. If the flow causes the oxygen level to fall below this limit, dangerous exhaust products, including carbon monoxide and hydrogen, may be released from the system in unacceptable quantities.

The combustion oxidizer flow can also cause non-optimal system performance if the combustion oxidizer flow rate is too high. Excessive flow rates cause cooling of the system and waste system energy driving the flow through the system. In the particular case where the exhaust flow is recirculated back to form part or all of the fuel oxidizer flow, an excessive combustion oxidizer flow will cause excessive molecular oxygen in the exhaust flow and resulting excessive combustion of fuel prior to the anode.

In the case of hydrocarbons and oxygenates as fuel, the minimum air flow required to ensure complete fuel combustion in the system is defined by the following reaction stoichiometry:

CₙHₐO_{b}+(n+a/4−b/2)O₂→nCO₂+(a/2)H₂O

Consequently, a minimum limit for atomic oxygen-to-atomic carbon ratio at the fuel cell system inlet of (2+a/2n), referred to as the minimum ratio required for complete combustion, is recommended for hydrocarbons and oxygenates, which corresponds to a minimum dry air-to-fuel ratio of (n+a/4−b/2)/x, where x is the mole fraction of molecular oxygen in dry air. In operation, atomic oxygen-to-atomic carbon ratios between the minimum ratio required for complete combustion and 3 times the minimum ratio required for complete combustion at the fuel cell system inlet are recommended, atomic oxygen-to-atomic carbon ratios between the minimum ratio required for complete combustion and 2 times the minimum ratio required for complete combustion are preferred, and atomic oxygen-to-atomic carbon ratios between the minimum ratio required for complete combustion and 1.2 times the minimum ratio required for complete combustion are most preferred.

### BRIEF DESCRIPTION OF THE DRAWINGS

The foregoing features of embodiments will be more readily understood by reference to the following detailed description, taken with reference to the accompanying drawings, in which:

FIG. 1A is a schematic diagram of a portable fuel cell system according to an illustrative embodiment of the present invention.

FIG. 1B is a schematic diagram of a portable fuel cell system according to another illustrative embodiment of the present invention.

FIG. 1C is a schematic diagram of a portable fuel cell system incorporating a check valve according to one illustrative embodiment of the present invention.

FIG. 2 is a schematic diagram of a portable fuel cell system incorporating various flow control features according to an illustrative embodiment of the present invention.

FIGS. 3A, 3B, 3C, 3D and 3E are schematic diagrams of a portable fuel cell system incorporating a recirculation path according to an illustrative embodiment of the present invention.

FIG. 4 is a schematic diagram of a portable fuel cell system incorporating a thermally coupling member according to an illustrative embodiment of the present invention.

FIG. 5 is a perspective view of a portable fuel cell system incorporating a thermally coupling member according to an illustrative embodiment of the present invention.

### DETAILED DESCRIPTION OF SPECIFIC EMBODIMENTS

Definitions. As used in this description and the accompanying claims, the following terms shall have the meanings indicated, unless the context otherwise requires:

A “fuel cell” is any portion of the system containing at least part of the electrochemical conversion structures, including an anode, electrolyte and cathode, and also including portions of the housings and flow conduits coupled to the electrochemical structures.

A “thermally coupling member” is a component or construction of the system which encourages heat transfer between objects, for example heat transfer may be accomplished by direct physical contact, coupling with a thermally conductive body, or conductive and radiative transfer due to proximity.

Various embodiments herein provide a portable fuel cell system and related method that result in such a system that is less expensive than prior art systems, less bulky and more compact in comparison with prior art systems, and less complicated in maintenance and operation in comparison with prior art systems.

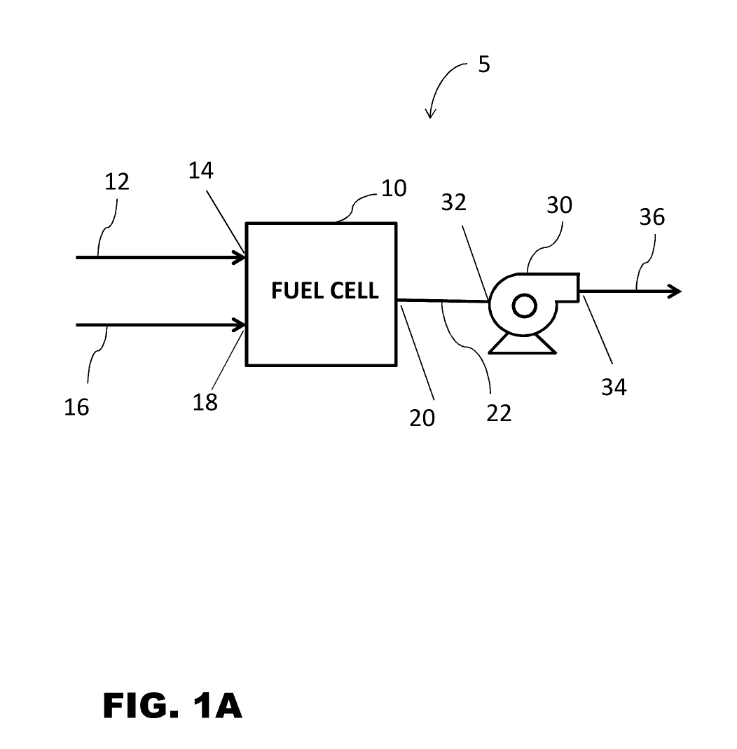

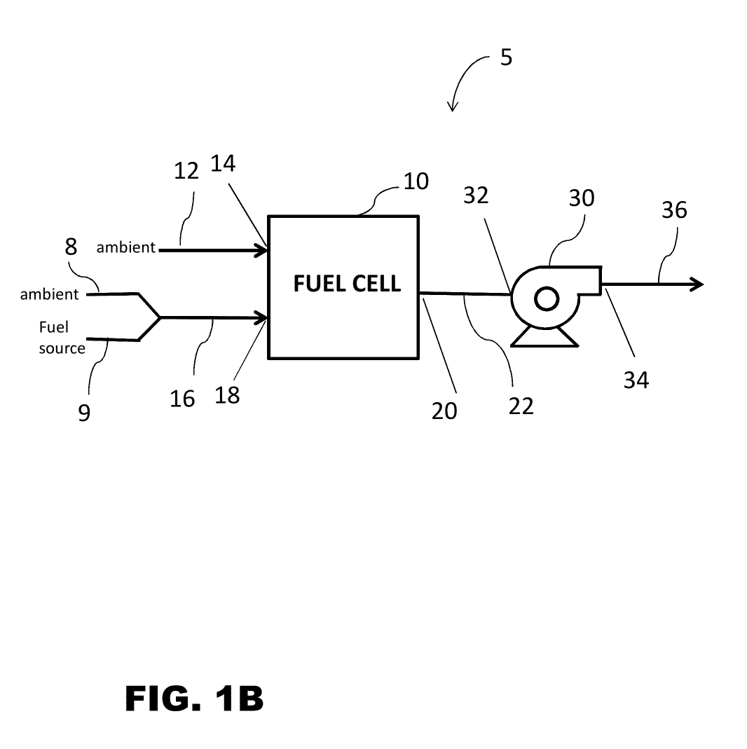

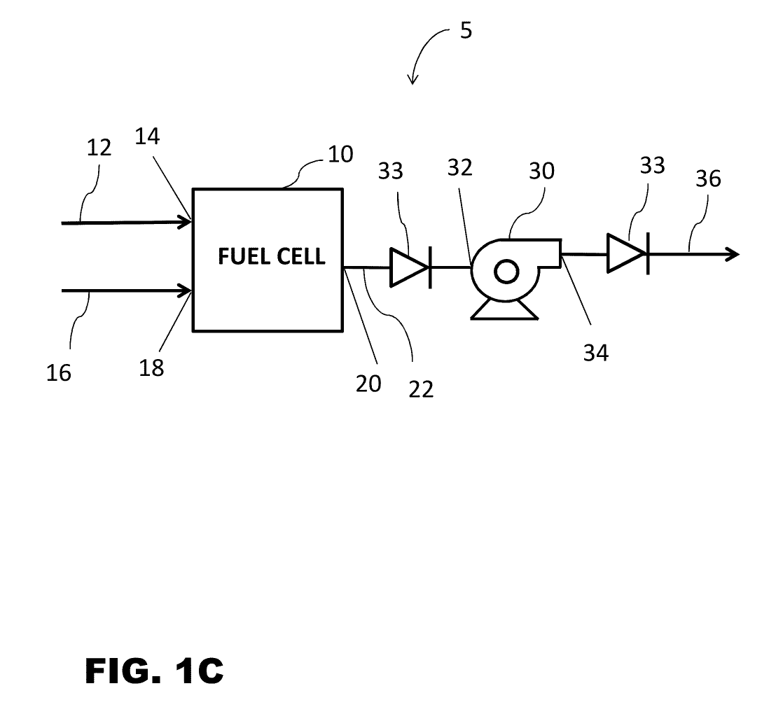

FIG. 1A illustrates one embodiment of portable fuel cell system 5, which includes a fuel cell 10 having anode port 18 through which passes an anode gas, cathode port 14 through which passes a cathode gas, and exhaust port 20 through which passes an exhaust gas. The fuel cell system 5 also includes a pump 30 having pump inlet 32 and pump outlet 34, wherein the pump inlet 32 is coupled to the exhaust port 20 of the fuel cell 10 and the pump outlet 34 is coupled to exit path 36. The pump 30 is configured to draw the anode gas into the anode port 18 along anode gas flow path 16, to draw the cathode gas into the cathode port 14 along cathode gas flow path 12, and to draw the exhaust gas out of the exhaust port 20 along exhaust gas flow path 22.

In operation, the fuel cell system 5 allows the pump 30 to create a reduced pressure at the exhaust port 20, thereby drawing the exhaust gas out of the exhaust port 20, the anode gas into the anode port 18, and the cathode gas into the cathode port 14.

Combining anode and cathode exhaust gases into one exhaust stream before it exits the exhaust port produces a number of beneficial results. For instance, it allows for the combustion of unburned fuel remaining in the anode gas, which causes heat to be released in the fuel cell 10. Moreover, combining the gas streams before they leave the fuel cell 10 reduces the number of individual flow streams going into and out of the fuel cell 10, which simplifies the heat recovery systems needed to ensure the incoming gases are preheated by the exhaust gas.

The fuel cell 10 can include a high temperature fuel cell, such as solid oxide fuel cell (SOFC) or molten carbonate fuel cell (MCFC). The fuel cell 10 can include other types of fuel cells such as proton exchange membrane fuel cell (PEMFC), polymer electrolyte membrane (PEM), or phosphoric acid fuel cell (PAFC). Preferably, the fuel cell 10 is a SOFC, such as described in U.S. Pat. No. 7,897,292 to Schaevitz et al., the contents of which are incorporated herein by reference in its entirety. The fuel cell 10 can include an individual fuel cell or can include a plurality of fuel cells connected together to form a stacked fuel cell structure. For example, individual fuel cells can be connected in a series to increase voltage.

According to embodiments of the present invention, the pump 30 can be any type of pump suitable for use in a portable fuel cell system. Suitable pumps include, but are not limited to, diaphragm pumps (e.g., model 200 EC commercially available from Schwarzer Precision GmbH+Co. KG, Am Lichtbogen 7, 45141 Essen, Germany), and vane pumps (e.g., model 135 FZ commercially available from Schwarzer Precision). Similar pumps, and pumps based on other technologies, are available from various suppliers, such as known by those skilled in the art. Preferably, the pump is constructed to be tolerant of elevated temperature operation and liquid water.

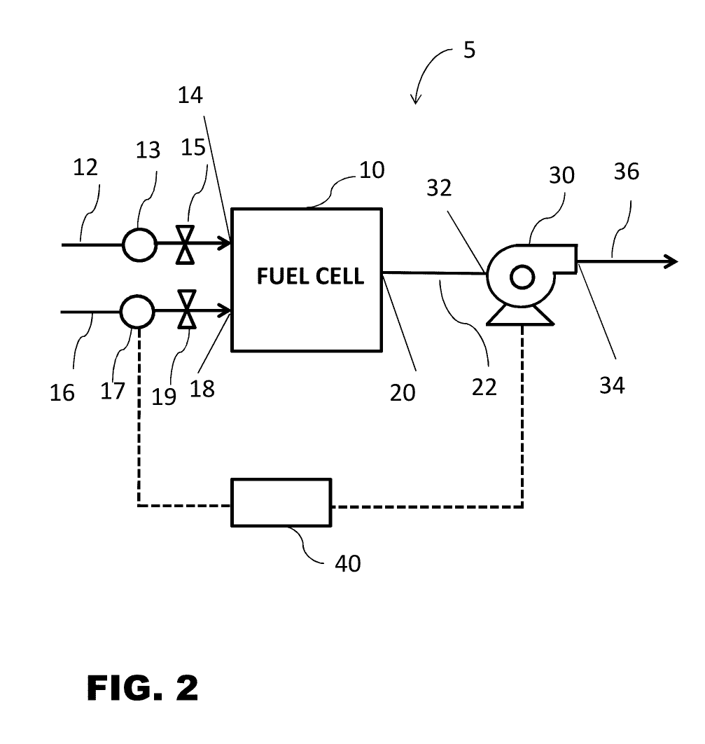

According to some embodiments, as illustrated in FIG. 1B, the cathode port 14 may be coupled to the ambient environment via the cathode gas flow path 12 and the anode port 18 may be coupled to a fuel source (via flow path 9), the ambient environment (via flow path 8), or both, through the anode gas flow path 16. For example, the cathode gas can include air and the anode gas can include a mixture of a hydrogen-based fuel source (e.g., butane, methane, or propane) and air. As shown in FIG. 2, the portable fuel cell system 5 may additionally include flow restriction 19 in the anode gas flow path 16 going into the anode port 18 or/and flow restriction 15 in the cathode gas flow path 12 going into the cathode port 14. The flow restrictions 15, 19 may modify a ratio of anode gas flow to cathode gas flow. For example, there may be a flow restriction in only one flow path and not in the other path (e.g., the flow restriction 19 in anode gas flow path 16 and no flow restriction in the cathode gas flow path 12, or vice versa). The flow restrictions 15 and 19 can include a fixed orifice, a manually adjustable valve, an electrically adjustable valve, or any combination thereof. For example, flow restriction 15 and flow restriction 19 can be the same type (e.g., both fixed orifices, both manually adjustable valves, or both electrically adjustable valves) or the flow restriction 15 may be different from flow restriction 19 (e.g., flow restriction 15 can be a fixed orifice and flow restriction 19 can be a manually adjustable valve, or vice versa, flow restriction 15 can be a manually adjustable valve and flow restriction 19 can be an electrically adjustable valve, or vice versa, etc.).

In some instances, as illustrated in FIG. 1C, the portable fuel cell system 5 can further include at least one check valve 33 in a flow path 22 into the pump inlet 32 or pump outlet 34. The valve 33 is configured to allow the majority of gas to flow through it in only one direction, while preventing flow in the opposite direction. There can be only one check valve in one of the flow paths, or two check valves, one in each flow path, as shown in FIG. 1C, or more than two check valves, for example, one check valve in the flow path into the pump inlet and two check valves in the flow path into the pump outlet, and so forth.

According to some embodiments of the present invention, the anode gas may include at least a fuel containing carbon and an oxidant containing oxygen. Mixing an oxygen containing gas with the fuel prior to introduction into the anode allows for a reforming reaction to occur either in a dedicated reformer or within the anode of the fuel cell 10. The reforming reactions convert more complex fuels, for example butane gas, into more simple molecules such as hydrogen and carbon monoxide. Fuel cells often require or are more efficient when fed with simple molecules. If insufficient oxygen is provided, the mixture may cause damage to some types of fuel cells. However, if excess oxygen is provided, then the fuel may be prematurely consumed before it has generated electricity in the fuel cell. The one or more flow restrictions described above are selected to provide a mixture of fuel and oxidant in a specified ratio of oxygen to carbon atoms. Preferably, the oxygen atom to carbon atom ratio is selected from the range between 0.5 and 2 oxygen atoms per carbon atom.

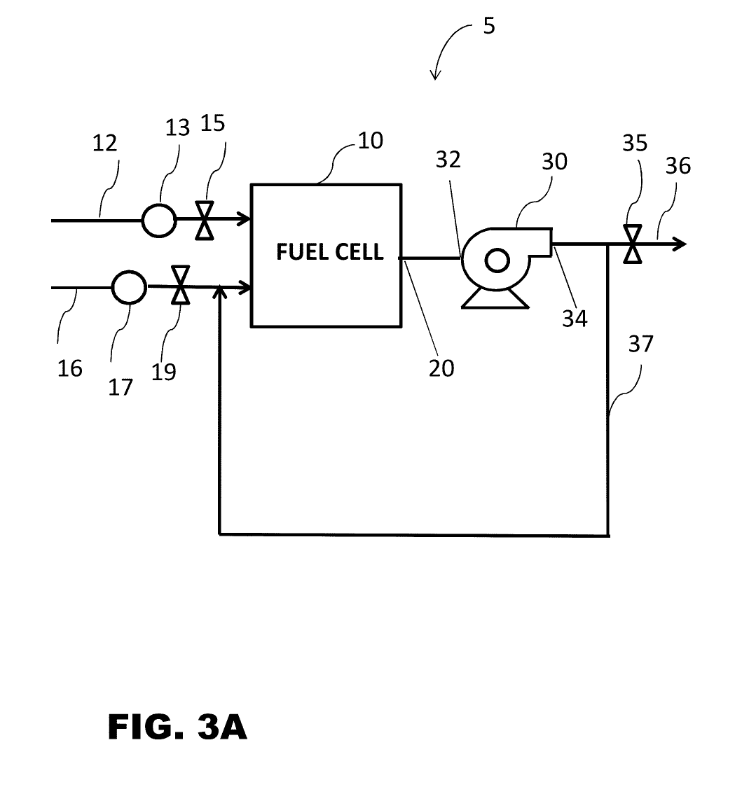

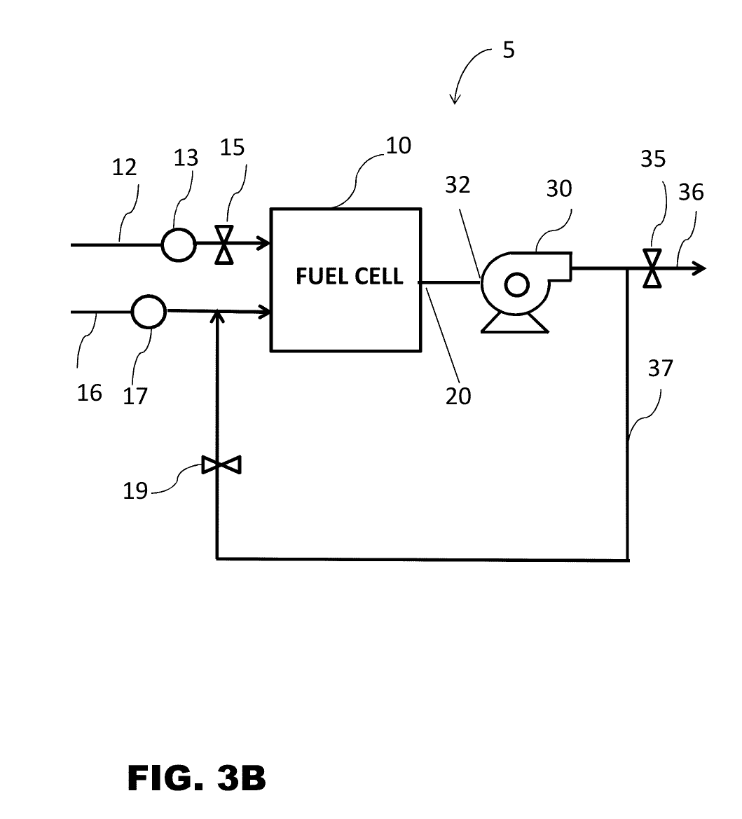

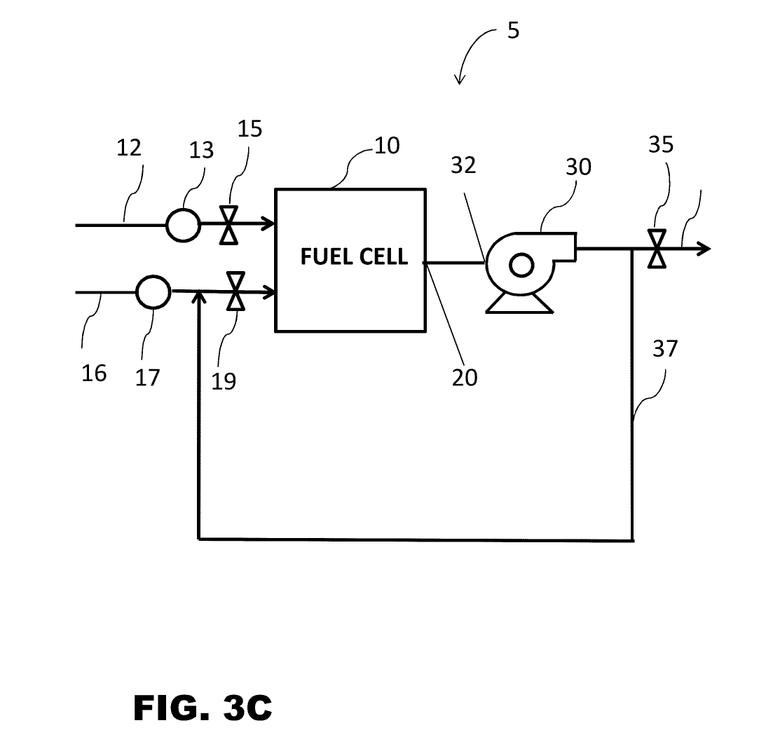

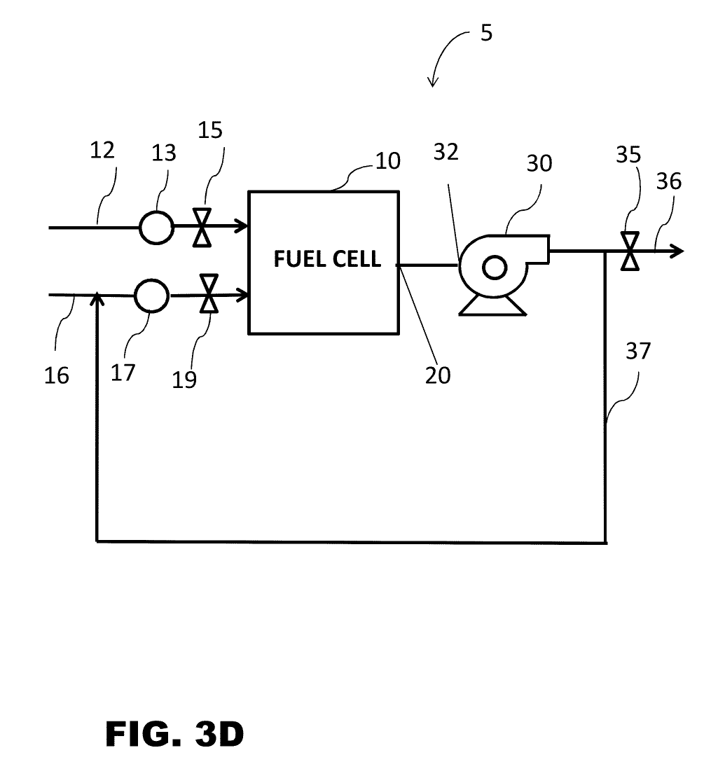

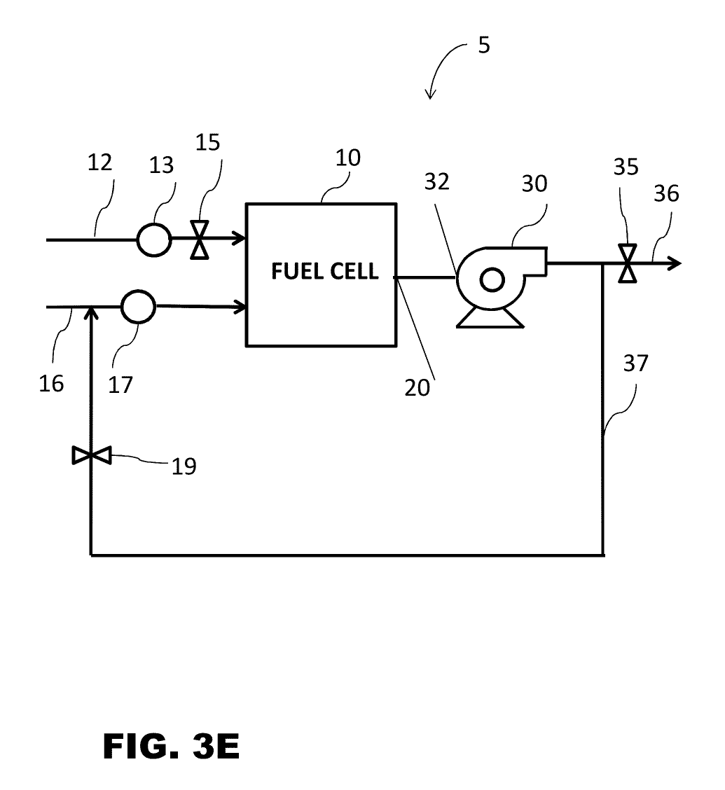

As shown in FIG. 2, the portable fuel cell system 5 may further include one or more flow sensors 13, 17 located in the anode gas flow path 16 going into the anode port 18 and/or the cathode gas flow path 12 going into the cathode port 14. For example, the flow sensor 17 may be located in the anode gas flow path 16 before, or upstream of, the flow restriction 19, such as shown in FIG. 2, or after, or downstream of, the flow restriction 19, as discussed in more detail below in connection with FIG. 3E. Alternatively, or in addition, the flow sensor 13 may be located in the cathode gas flow path 12 before the flow restriction 15 (as shown in FIG. 2), or after the flow restriction 15. The flow sensor(s) 13, 17 may be configured to measure a gas flow.

Various flow sensors known to those of ordinary skill in the art may be incorporated in embodiments of the present system. In particular, suitable sensors include, but are not limited to flow rate sensors and MEMS flow sensors (e.g., model D6F commercially available from Omron Electronic Components, 55 Commerce Drive, Schaumburg, Ill. 60173 US). The flow sensors 13, 17 may be direct or indirect mass flow sensors, although other sensors may also be used as appropriate. In other embodiments, the flow sensors 13, 17 are volume flow sensors, and an electronic circuit corrects for the expected difference in volume flow rate. In other embodiments, the flow sensing is performed by measuring a pressure difference across one or more of the flow restrictions 15, 19 and/or flow restriction 35 (as shown in FIG. 3A).

As shown in FIG. 2, the portable fuel cell system 5 may further include a control system 40, in electrical communication with one or more of the flow sensors 13, 17 and the pump 30. The control system 40 may be configured to modulate the pump 30 in response to measured gas flow. The control system 40 may be configured to send and receive data, such as gas flow, via various electrical connections (not shown). The control system 40 may include a control circuit, which is configured to send an electrical signal to the pump 30 in response to the measured gas flow to modulate the pump 30 so as to adjust a pumping rate accordingly.

According to another embodiment, as illustrated in FIG. 3A, pump outlet 34 is coupled to the exit path 36 and recirculation path 37 that is further coupled to the anode gas flow path 16 such that a portion of the anode gas includes a portion of the exhaust gas supplied via the recirculation path 37. After passing through a fuel reformer and a tail gas burner (not shown), the exhaust gas primarily includes water and carbon dioxide, which is suitable for diluting the anode gas. It was found that mixing the fuel, such as butane, with water and carbon dioxide before the fuel enters the fuel cell 10 produces beneficial results compared with mixing with ambient air, because more molecules of carbon monoxide and hydrogen are generated when the diluted fuel reacts with water or carbon dioxide instead of with molecular oxygen in ambient air. Another benefit of diluting the fuel with the exhaust gas containing carbon dioxide and water is that such dilution affects the thermodynamics of the reaction taking place in the fuel cell 10 by rendering it more endothermic, which results in absorption of energy and improvement in system efficiency.

As previously discussed with regard to FIG. 2, the system can additionally include one or more flow restrictions 15, 19 in the anode gas flow path 16 and/or the cathode gas flow path 12 for modifying a ratio of anode gas flow to cathode gas flow. Alternatively, or in addition, the system can include flow restriction 35 in the exit path 36, as shown in FIG. 3A, so as to modify a ratio of the recirculation gas flow to the cathode gas flow. When the anode gas comprises at least a fuel containing carbon and an oxidant containing oxygen, flow restrictions 15, 19, and/or 35 can be selected to provide a mixture of fuel and oxidant in a specified ratio of oxygen to carbon atoms. Preferably, the oxygen atom to carbon atom ratio is selected from the range between 0.5 and 2 oxygen atoms per carbon atom.

Alternatively, or in addition, other types of sensors can be incorporated in different embodiments of the present invention. Some suitable sensors include, but are not limited to, thermocouples, such as unsheathed fine wire thermocouples, Type R, 0.001″ diameter (e.g., model number P13R-001 commercially available from Omega Engineering, Inc.), platinum resistive temperature detector (RTD) (e.g., model number WS81 commercially available from Omega Engineering, Inc., One Omega Drive, Stamford, Conn. 06907-0047, USA). Sensors can be positioned to directly detect a particular parameter of interest or indirectly positioned to capture data from different sources. For example, a thermal sensor can be positioned to capture indirect heat that propagates along a flow path, even though it is integrated in the device to measure the temperature of the originating heat source.

Various sensors and control elements useful in the embodiments of the invention include, but are not limited to, a fluid flow detector, a pressure detector, a comparator circuit, a voltage detector, a current detector, a direct mass flow rate detector, an indirect mass flow rate detector, a volume flow detector, a differential detector, a feedback loop, a temperature detector, a radiation detector, a valve, a unidirectional flow device, a gasket, a seal, a gate, a membrane, an iris, an occluder, a vent, a conduit, and combinations thereof.

The sensors and valves may be located in various positions in the system, such as shown in FIGS. 3B-3E, although other configurations may also be used. For example, flow sensor 17 can be located downstream of, or after, flow restriction 19 (as shown in FIG. 3E) rather than upstream (as shown in FIGS. 2 and 3A-3D). Flow sensor 17 can also be located in recirculation path 37, or positioned upstream of pump 30 in the flow path connecting fuel cell 10 and pump 30, or downstream of pump 30 in exit path 36. Moreover, the recirculation path 37 can be coupled to the anode gas flow path 16 using different configurations, in relation to the flow sensor(s) 13, 17 and the flow restriction(s) 15, 19, 35, as illustrated in FIGS. 3A-3E. For example, in some embodiments, the recirculation path 37 is coupled to the anode gas flow path 16 downstream of, or after, the flow sensor 17 and flow restriction 19 (as shown in FIG. 3A), or upstream of, or before, the flow sensor 17 and flow restriction 19 (as shown in FIG. 3D). According to some embodiments, the recirculation path 37 is coupled to the portion of the anode gas flow path 16 that is located between the flow sensor 17 and the flow restriction 19 (as shown in FIG. 3C) or the recirculation path 37 is coupled to the anode gas flow path 16 upstream of, or before, the flow sensor 17, whereas, flow restriction 19 is located in the recirculation path 37 (as shown in FIG. 3E).

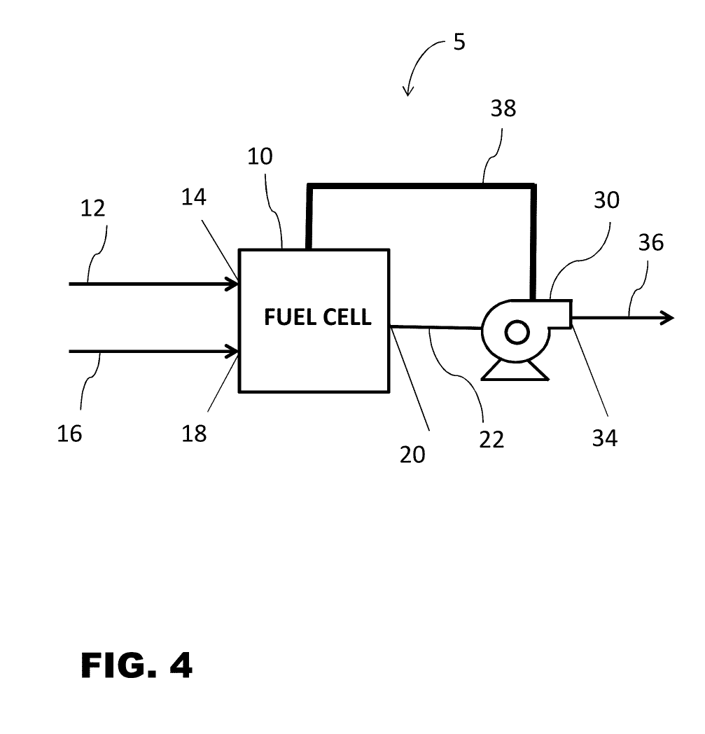

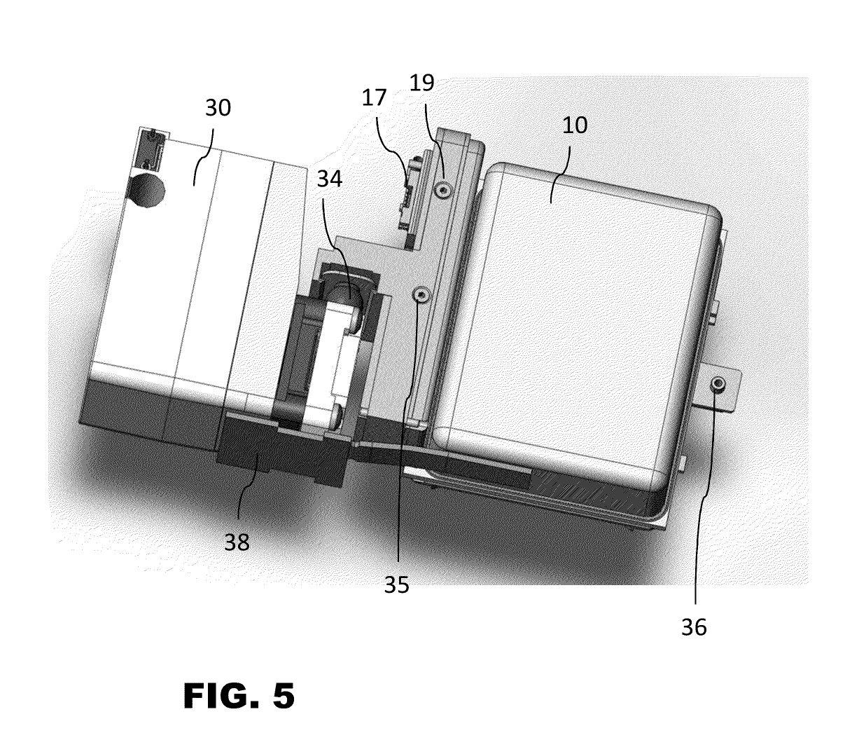

The oxidation process that takes place in the fuel cell 10 produces heat, the excess of which can be transferred to the pump 30 to prevent condensation, which can reduce the pump 30 efficiency and also block the flow path thereby changing the pressure drop and hence alter flow ratios during the recirculation of the exhaust gas. In order to solve this problem, in some embodiments of the present invention, there is provided a thermally coupling member, such as thermally coupling member 38 as illustrated in FIGS. 4-5. The thermally coupling member 38 is in thermal communication with the pump 30 and in thermal communication with the fuel cell 10. The thermally coupling member 38 may be a metal strip, a heat pipe, thermal grease, and/or forced hot air. In the embodiment shown in FIG. 5, the thermally coupling member 38 is formed from a copper strip placed in contact with the fuel cell 10 and the pump 30. In some instances, the thermal coupling can be achieved by placing the fuel cell 10 and the pump 30 in a direct physical contact. As described above, the thermally coupling member 38 is capable of providing sufficient heat from the fuel cell 10 to the pump 30 as to inhibit condensation of water in the pump 30, which could adversely affect the pump efficiency and alter the recirculation flow of the exhaust gas.

The embodiments of the invention described above are intended to be merely exemplary; numerous variations and modifications will be apparent to those skilled in the art. All such variations and modifications are intended to be within the scope of the present invention as defined in any appended claims.

What is claimed is:

1. A portable fuel cell system comprising:
a fuel cell comprising an anode port through which passes an anode gas, a cathode port through which passes a cathode gas, and an exhaust port through which passes an exhaust gas; and
a pump, having a pump inlet and a pump outlet, wherein the pump inlet is coupled to the exhaust port, and configured to draw the anode gas into the anode port, to draw the cathode gas into the cathode port, and to draw the exhaust gas out of the exhaust port.

2. A portable fuel cell system according to claim 1, the system further comprising a flow restriction in a flow path into the anode port or into the cathode port, or both, so as to modify a ratio of anode gas flow to cathode gas flow.

3. A portable fuel cell system according to claim 2, wherein the anode gas comprises at least a fuel containing carbon and an oxidant containing oxygen, wherein the flow restriction is configured to provide a ratiometric mixture of fuel and oxidant such that for each carbon atom in the fuel there is supplied a number of oxygen atoms in the oxidant in a ratio, and the ratio is within the range between 0.5 and 2 oxygen atoms per carbon atom.

4. A portable fuel cell system according to claim 2, wherein the anode gas comprises at least a fuel containing carbon and an oxidant containing oxygen, wherein the flow restriction is configured to provide a ratiometric mixture of fuel and oxidant such that for each carbon atom in the fuel there is supplied a number of oxygen atoms in the oxidant in a ratio, and the ratio is within the range between 1 and 2 oxygen atoms per carbon atom.

5. A portable fuel cell system according to claim 2, wherein the anode gas comprises at least a fuel containing carbon and an oxidant containing oxygen, wherein the flow restriction is configured to provide a ratiometric mixture of fuel and oxidant such that for each carbon atom in the fuel there is supplied a number of oxygen atoms in the oxidant in a ratio, and the ratio is within the rangeless than 2 and greater than 1.025, 1.251 and 1.645 oxygen atoms per carbon atom at 850° C., 720° C., and 650° C., respectively.

6. A portable fuel cell system according to claim 2, wherein the flow restriction is selected from the group consisting of a fixed orifice, a manually adjustable valve, an electrically adjustable valve, and combinations thereof.

7. A portable fuel cell system according to claim 1, wherein the pump is configured to draw the anode gas into the anode port along an anode gas flow path, the cathode port is coupled to ambient environment, and the anode gas flow path is coupled to at least a fuel source and the ambient environment.

8. A portable fuel cell system according to claim 1, wherein the pump is configured to draw the anode gas into the anode port along an anode gas flow path, and the pump outlet is coupled to an exit path and a recirculation path, the recirculation path further coupled to the anode gas flow path such that a portion of the anode gas comprises a portion of the exhaust gas supplied via the recirculation path.

9. A portable fuel cell system according to claim 8, the system further comprising a flow restriction in the anode gas flow path into the anode port, in a flow path into the cathode port, or both, so as to modify a ratio of anode gas flow to cathode gas flow.

10. A portable fuel cell system according to claim 8, the system further comprising a flow restriction in the exit path, so as to modify a ratio of recirculation gas flow to cathode gas flow.

11. A portable fuel cell system according to claim 10, wherein the anode gas comprises at least a fuel containing carbon and an oxidant containing oxygen, the flow restriction is configured to provide a ratiometric mixture of fuel and oxidant such that for each carbon atom in the fuel there is supplied a number of oxygen atoms in the oxidant in a ratio, and the ratio is within the range between 0.5 and 2 oxygen atoms per carbon atom.

12. A portable fuel cell system according to claim 9, wherein the anode gas comprises at least a fuel containing carbon and an oxidant containing oxygen, the flow restriction is configured to provide a ratiometric mixture of fuel and oxidant such that for each carbon atom in the fuel there is supplied a number of oxygen atoms in the oxidant in a ratio, and the ratio is within the range between 0.5 and 2 oxygen atoms per carbon atom.

13. A portable fuel cell system according to claim 1, the system further comprising a thermally coupling member in thermal communication with the pump and in thermal communication with the fuel cell.

14. A portable fuel cell system according to claim 13, wherein the thermally coupling member is selected from the group consisting of a metal strip, a heat pipe, thermal grease, forced hot air, physical contact, and combinations thereof.

15. A portable fuel cell system according to claim 13, wherein the thermally coupling member provides sufficient heat from the fuel cell to the pump to inhibit condensation of water in the pump.

16. A portable fuel cell system according to claim 1, further comprising at least one flow sensor located in a flow path into the anode port or into the cathode port, or both, said flow sensor configured to measure a gas flow, and further comprising a control system in electrical communication with the flow sensor and the pump, said control system configured to modulate the pump in response to measured gas flow.

17. A portable fuel cell system according to claim 1, further comprising at least one check valve in a flow path into the pump inlet or pump outlet, configured such that the majority of gas passing therethrough is in one direction of flow.

18. A portable fuel cell system according to claim 1, wherein said fuel cell is a solid oxide fuel cell.

19. A method for operating a fuel cell system, said method comprising:
providing a fuel cell with an anode port, a cathode port and an exhaust port, and a pump with a pump inlet and a pump outlet, the pump inlet coupled to the exhaust port; and
operating the pump to create a reduced pressure at the exhaust port, thereby drawing the exhaust gas out of the exhaust port, the anode gas into the anode port, and the cathode gas into the cathode port.

20. A method for operating a fuel cell system according to claim 19, the method further comprising providing a flow restriction in a flow path into the anode port or into the cathode port, or both, so as to modify a ratio of anode gas flow to cathode gas flow.

21. A method for operating a fuel cell system according to claim 20, wherein the flow restriction is selected from the group consisting of a fixed orifice, a manually adjustable valve, an electrically adjustable valve, and combinations thereof.

22. A method for operating a fuel cell system according to claim 19, wherein drawing the anode gas into the anode port is accomplished along an anode gas flow path, the method further comprising coupling the pump outlet to an exit path and a recirculation path, and additionally coupling the recirculation path to the anode gas flow path such that a portion of the anode gas comprises a portion of the exhaust gas supplied via the recirculation path.

23. A method for operating a fuel cell system according to claim 19, the method further comprising providing a thermally coupling member in thermal communication with the pump and in thermal communication with the fuel cell.

24. A method for operating a fuel cell system according to claim 23, wherein the thermally coupling member is selected from the group consisting of a metal strip, a heat pipe, thermal grease, physical contact, and combinations thereof.

25. A method for operating a fuel cell system according to claim 23, the method further comprising providing sufficient heat from the fuel cell to the pump to inhibit condensation of water in the pump.

26. A method for operating a fuel cell system according to claim 19, the method further comprising:
providing at least one flow sensor located in a flow path into the anode port or into the cathode port, or both, said flow sensor configured to measure a gas flow;
providing a control system in electrical communication with the flow sensor and the pump; and
modulating the pump in response to measured gas flow.

27. A method for operating a fuel cell system according to claim 19, wherein said fuel cell is a solid oxide fuel cell.
